(19) United States
(12) Patent Application Publication
(10) Pub. No.: US 2009/0113722 A1
(43) Pub. Date: May 7, 2009

(54) SAFETY ATTACHMENT COMBS

(76) Inventors: Edwin A. Werner, Union Grove, WI (US); Matthew K. Andis, Sturtevant, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/935,027

(22) Filed: Nov. 5, 2007

(51) Int. Cl. B26B 19/20; B26B 19/00

(52) U.S. Cl. 30/200; 132/213.1; 30/233.5

(57) ABSTRACT

An attachment comb for a hair trimmer having a blade includes a comb body having a leading edge and a trailing edge, the trailing edge defining an attachment member for attaching the comb body to the hair trimmer and a plurality of tines. Each of the plurality of tines has a rounded end, and the rounded end is defined by a first corner and a second corner.

### BACKGROUND

The present invention relates to attachment combs for hair trimmers, which are removably attachable to a hair trimmer to assist an operator in cutting hair to achieve various styling textures and cuts.

A standard attachment comb is used to control the length of hair being cut, whereby various attachment combs are used to create different hair cut lengths. Current attachment combs generally have pointed ends on each comb tine. The pointed ends maneuver the comb through hair being cut; however, the pointed ends can cause discomfort or injury if poked into the head or body of the hair being cut. Since animals and humans can sometimes be unpredictable when being groomed, a sudden turn of the head or panic from an animal can cause the pointed ends to unintentionally, uncomfortably contact the animal or human whose hair is being cut. The pointed ends and the potential for causing discomfort may also make the operator of the attachment comb weary and unsure during operation, thereby increasing the potential for improper use of the pointed end of the comb attachment.

### SUMMARY

In one embodiment, the invention provides an attachment comb for a hair trimmer having a blade. The attachment comb includes a comb body including a leading edge and a trailing edge, the trailing edge defining an attachment member for attaching the comb body to the hair trimmer and a plurality of tines. Each of the plurality of tines has a rounded end, and the rounded end is defined by a first corner and a second corner.

In another embodiment the invention provides an attachment comb for a hair trimmer having a blade. The attachment comb includes a comb body including a leading edge and a trailing edge, wherein the trailing edge defines an attachment member for attaching the comb body to the hair trimmer and a plurality of tines. Each of the plurality of tines includes a first edge, a second edge, and a tip. The first edge and the second edge define the tip. The first edge has a first corner proximate the tip, and the second edge has a second corner proximate the tip.

In another embodiment, the invention provides a hair cutting system for cutting hair. The system includes a hair trimmer and an attachment comb configured to be removably coupled to the hair trimmer. The attachment comb has a comb body including a leading edge and a trailing edge, wherein the trailing edge defines an attachment member for attaching the comb body to the hair trimmer, and a plurality of tines at the leading edge of the comb body. Each of the plurality of tines comprises a rounded end, wherein the rounded end is defined by a first corner and a second corner.

Other aspects of the invention will become apparent by consideration of the detailed description and accompanying drawings.

### BRIEF DESCRIPTION OF THE DRAWINGS

FIG. 1 is a perspective view of an attachment comb according to one embodiment of the invention, the comb attachment illustrated attached to a hair trimmer.

FIG. 2 is a top perspective view of the attachment comb shown in FIG. 1.

FIG. 3 is a bottom perspective view of the attachment comb shown in FIG. 1.

FIG. 4 is a side view of the attachment comb shown in FIG. 1.

FIG. 4A is a detailed view of the comb tip shown in FIG. 4.

FIG. 5 is a side view of a standard-tipped attachment comb in operation on a human head, shown at a proper approach angle.

FIG. 6 is a side view of the attachment comb of FIG. 1 in operation on a human head, shown at a proper approach angle.

FIG. 7 is a side view of the attachment comb of FIG. 1 in operation on a human head, shown at an improper approach angle.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

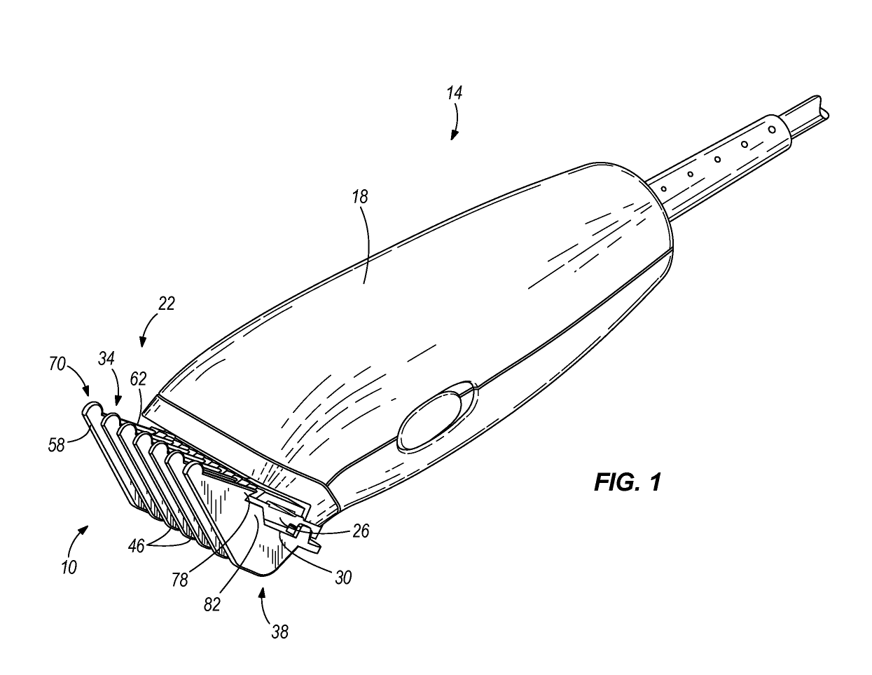

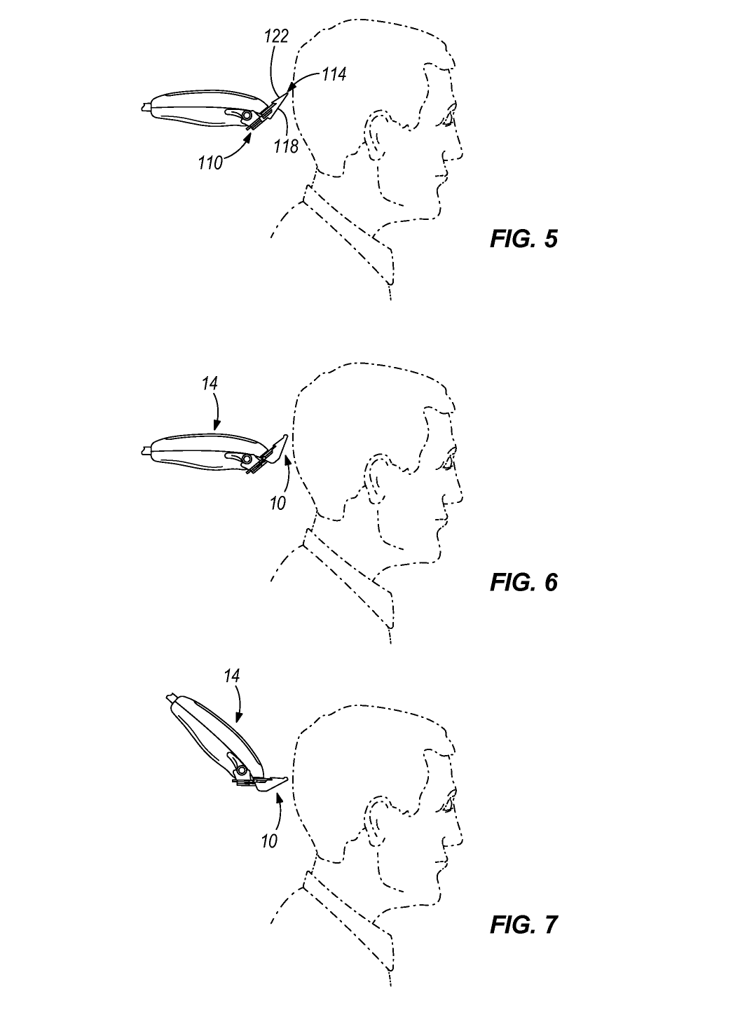

FIGS. 1-4A illustrate a hair attachment comb 10 according to one embodiment of the invention. FIG. 5 illustrates a standard tipped comb 110 in operation and approaching a human head at a proper approach angle. FIGS. 6-7 illustrate the hair attachment comb 10 of the present invention and approaching a human head at a proper approach angle and an improper approach angle, respectively. It should be readily apparent to one of ordinary skill in the art that the present invention may also be utilized with any hair trimmer or hair clipper suitable for blade or attachment comb.

Referring to FIG. 1, the attachment comb 10 is removably attachable to a hair trimmer 14. The hair trimmer 14 includes a hollow, elongated body portion 18 having a cutting end 22. The elongated body 18 supports a blade 26 on the cutting end 22. As the hair trimmer 14 is guided through a person's hair, reciprocating motion of the blade 26 cuts the person's hair. A number of suitable blades, blade sets, motors, and driving arrangements are known. It should be appreciated that hair trimmers having other types of blades, blade sets, motors, and/or driving arrangements would be suitable for use in combination with the present invention. The attachment comb is used in conjunction with the hair trimmer to assist a trimmer operator with the cutting and styling of hair.

In the illustrated embodiments of FIGS. 1-4, the attachment comb 10 includes a comb body 30 having a leading edge 34 and a trailing edge 38, an attachment member 42, and a plurality of tines 46. The leading edge 34 generally contacts the hair to be cut before the trailing edge 38 contacts the hair to be cut. The attachment member 42 is generally located at the trailing edge 38 of the comb body 30 and is configured to facilitate coupling of the attachment comb 10 to the hair trimmer 14 at the cutting end 22 of the hair trimmer 14. The attachment member 42 couples the attachment comb 10 to the hair trimmer 14 with a clip-on configuration. In other embodiments, the attachment member couples the attachment comb to the hair trimmer in any number of manners, including, but not limited to, a snap-on configuration, an adhesive strip, and the like.

The comb body 30 includes a plurality of tines 46. The tines 46 extend from the comb body 30 and adjacent tines 46 define a hair guide slot 50. A width 54 of each of the hair guide slots 50 may be equal on an attachment comb; however, in other embodiments, the width of the hair guide slots may vary. The slot width 54 of the hair guide slots defines the amount of hair to be cut. By way of example only, a wider hair guide slot enables more hair to be cut than a more narrow hair guide slot. Additionally, the number of hair guide slots on an attachment comb affects the amount of hair to be cut. In combination, the number of hair guide slots and the width of the hair guide slots enable an operator of a hair trimmer to create different effects in hair-cutting by use of different attachment combs.

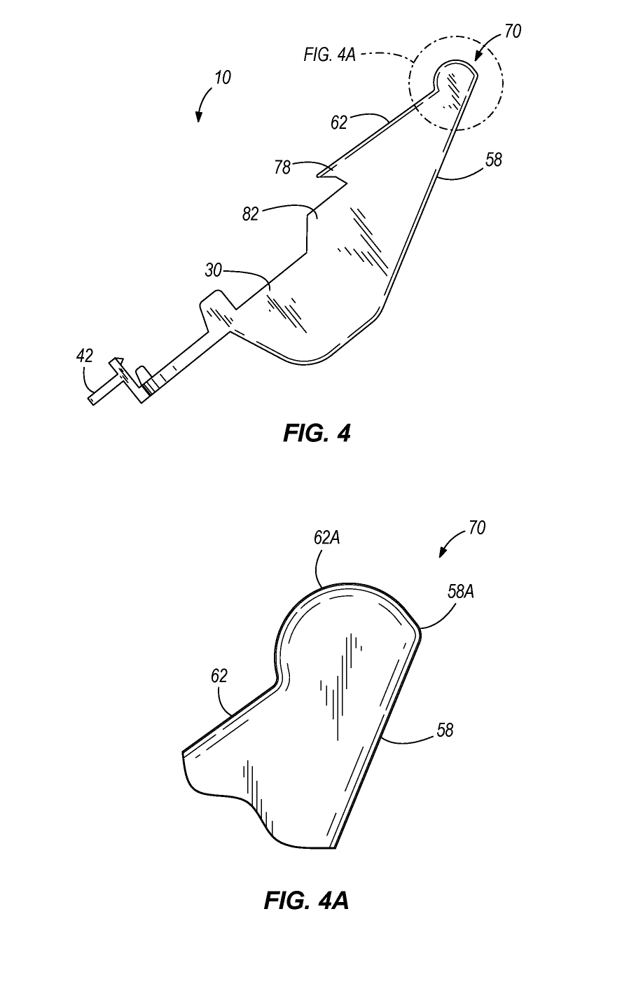

In the illustrated embodiment of FIGS. 4 and 4A, each of the plurality of tines 46 includes a first edge 58 and a second edge 62. The first edge 58 of the tine 46 includes a first corner 58A and is configured to maintain continuous contact with the head or body of hair being cut. In the illustrated embodiment, the first corner 58A is rounded. The second edge 62 includes a second corner, or extension 62A. The second corner 62A is configured to prevent poking of the tine into the head or body of hair being cut. In the illustrated embodiment, the second corner 62A is shown as having a substantially semi-circular shape. In further embodiments, the second corner 62A is generally convex or outwardly curved, to prevent poking of the tines into the head or body of hair being cut, and the corner shape may include, but is not limited to, elliptical, round, or other non-circular shape. The first edge 58 and second edge 62 meet to define a tip 70 adjacent the leading edge 34 of the comb body. In the illustrated embodiment, the tip 70 has a rounded end. The tip 70 includes the first corner 58A and the second corner 62A.

In the illustrated embodiment, the first corner 58A has a radius of approximately 1/32-inch. In other embodiments, the first corner may have a radius smaller or larger than 1/32-inch. The first corner 58A is configured to feed hair into the hair guide slot 50 and maintain close contact of the attachment comb 10 to the head or body of hair being cut. In the illustrated embodiment, the second corner 62A has a radius of approximately ⅛-inch; however in other embodiments, the second corner may have a radius in a range from 3/32-inch to ¼-inch.

The second corner 62A provides a safety feature to prevent injury or discomfort to a head or body of hair being cut that is not present in the pointed end 114 of a standard attachment comb 110 shown in FIG. 5. Referring to FIG. 5, the standard attachment comb 110 has smooth first and second edges 118, 122 that meet to define the pointed tip 114, which could potentially cause injury or discomfort if used at an improper angle on a head or body of hair being cut.

Each of the plurality of tines 46 further includes an attachment ledge 78. The attachment ledge 78 is positioned on the end of the tine opposite the tip 70 of the tine 46. The attachment ledge 78 is configured to retain the attachment comb 10 on the blade 26 of the trimmer 14, as shown in FIG. 1. The attachment ledge 78 also promotes the proper installation of the attachment comb 10 because the attachment ledge 78 effectively prevents installation or removal of the attachment comb 10 without properly engaging the attachment member 42 on the rear of the comb body 30. The attachment ledge 78 overhangs the blade 26 to prevent the user from improperly removing the attachment comb 10 from the front of the blade 26. In the illustrated embodiment, the tines 46 narrow in width from the attachment ledge 78 to the tip 70, which facilitates proper removal of the attachment comb from the manufacturing tool. In other embodiments, the tines may be of uniform width or the tines may get wider from the attachment ledge to the rounded end.

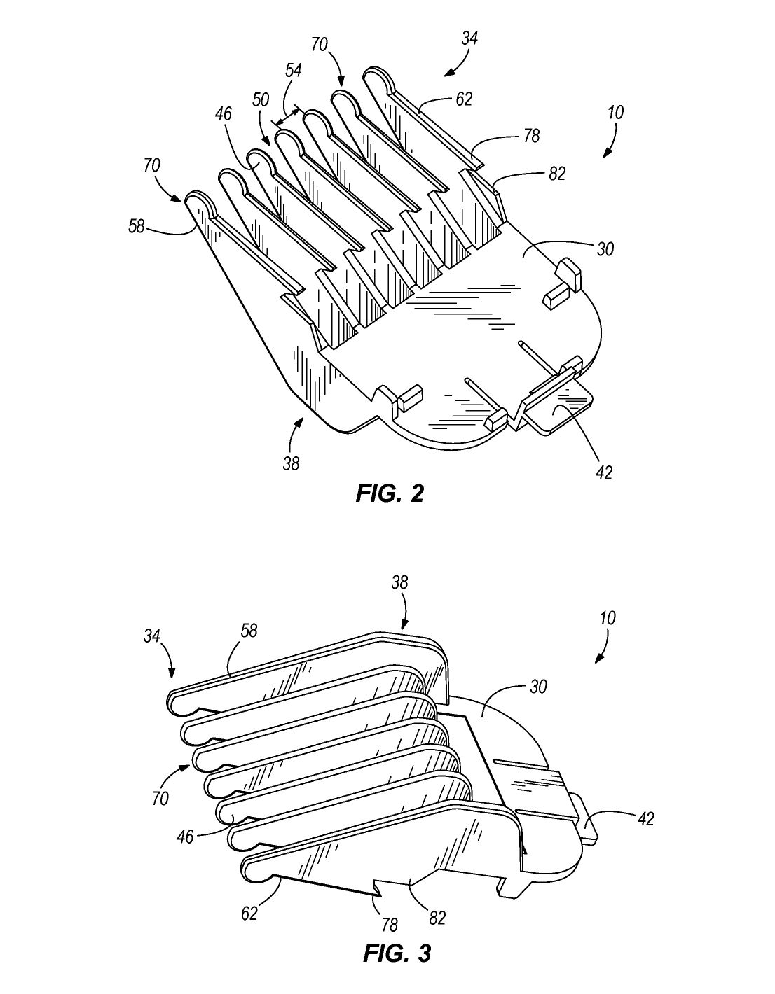

The attachment comb 10 further includes a blade guide 82. The blade guide 82 is configured to guide placement of the attachment comb 10 onto the blade 26 of the trimmer 14. The blade guide 82 is shown in FIGS. 2-3 on each of a side of the comb body 30. However, in other embodiments, the blade guide 82 can be positioned at any location on the comb body where the blade guide can still function as a blade guide without interfering with other functions of the attachment comb. The blade guides also provide a covering for the sides of the moving blade.

In operation and with further reference to FIGS. 6 and 7, the second corner 62A provides a safety and comfort feature to the attachment comb 10 in addition to providing the combing function. FIG. 6 shows the attachment comb 10 being used at a proper angle to cut hair. The attachment comb 10 is angled such that it can move through the hair without poking into the head. FIG. 7 shows the attachment comb 10 being used at an improper angle to cut hair. Although being used at an improper angle, the second corner 62A of the attachment comb 10 will prevent harm to the customer. The second corner 62A prevents unnecessary poking into the head of the customer, thereby increasing customer comfort and operator confidence since no sharp tip exists to poke into the customer and cause harm. It is also advantageous to have a first corner that is smaller than the second corner to promote feeding of the hair into hair guide slots, maintaining close contact of the attachment comb with the skin, preventing hair from folding over adjacent tines, and allowing for effective combing action by combing through the hair rather than riding over the hair.

Other embodiments of the present invention may utilize combinations of the above embodiments. The embodiments described above and illustrated in the figures are presented by way of example only and are not intended as a limitation upon the concepts and principles of the present invention. As such, it will be appreciate by one having ordinary skill in the art that various changes in the elements and their configuration and arrangement are possible without departing from the spirit and scope of the present invention. Various features and advantages of the invention are set forth in the following claims.

What is claimed is:

1. An attachment comb for a hair trimmer having a blade, the attachment comb comprising:
a comb body including a leading edge and a trailing edge, the trailing edge defining an attachment member for attaching the comb body to the hair trimmer; and
a plurality of tines,
wherein each of the plurality of tines has a rounded end; and
wherein the rounded end is defined by a first corner and a second corner.

2. The attachment comb of claim 1 wherein the second corner has a size greater than the first corner.

3. The attachment comb of claim 1 wherein the second corner has a radius between approximately 3/32-inch and approximately ¼-inch.

4. The attachment comb of claim 3 wherein the second corner has a radius of approximately ⅛-inch.

5. The attachment comb of claim 1 wherein the first corner has a radius of approximately 1/32-inch.

6. The attachment comb of claim 1, and further comprising a blade guide configured to guide placement of the attachment comb on the blade of the trimmer.

7. The attachment comb of claim 1, each of the plurality of times further comprising an attachment ledge configured to retain the attachment comb on the blade of the trimmer.

8. An attachment comb for a hair trimmer having a blade, the attachment comb comprising:
a comb body including a leading edge and a trailing edge, wherein the trailing edge defines an attachment member for attaching the comb body to the hair trimmer; and
a plurality of tines, each of the plurality of tines comprising:
a first edge;
a second edge; and
a tip, the first edge and the second edge defining the tip;
wherein the first edge has a first corner proximate the tip, and
wherein the second edge has a second corner proximate the tip.

9. The attachment comb of claim 9 wherein the first corner and second corner define a rounded end on the tip.

10. The attachment comb of claim 8 wherein the second corner has a convex shape.

11. The attachment comb of claim 8 wherein the second corner has a radius greater than a radius of the first corner.

12. The attachment comb of claim 8 wherein the first corner has a radius of approximately 1/32-inch.

13. The attachment comb of claim 8 wherein the second corner has a radius between approximately 3/32-inch and approximately ¼-inch.

14. The attachment comb of claim 13 wherein the second corner has a radius of approximately ⅛-inch.

15. The attachment comb of claim 8, and further comprising a blade guide configured to guide placement of the attachment comb on the blade of the trimmer.

16. The attachment comb of claim 8, each of the plurality of tines further comprising an attachment ledge configured to retain the attachment comb on the blade of the trimmer.

17. A hair cutting system for cutting hair, the system comprising:
a hair trimmer; and
an attachment comb configured to be removably coupled to the hair trimmer, the attachment comb having a comb body including a leading edge and a trailing edge, wherein the trailing edge defines an attachment member for attaching the comb body to the hair trimmer, and a plurality of tines at the leading edge of the comb body, wherein each of the plurality of tines comprises a rounded end, wherein the rounded end is defined by a first corner and a second corner.

18. The system of claim 17 wherein the second corner has a size greater than a size of the first corner.

19. The system of claim 17 wherein the rounded end is configured to provide substantially continuous combing of hair.

20. The system of claim 17, wherein each of the plurality of tines further comprises a first edge including the first corner and a second edge including the second corner.
